(19) United States
(12) Patent Application Publication
(10) Pub. No.: US 2004/0205768 A1
(43) Pub. Date: Oct. 14, 2004

(54) Arrangement for dynamically determining load-based frequency of system messages in a communications network

(76) Inventor: David R. Lott, Thornton, CO (US)

Correspondence Address: Docket Administrator, Avaya Inc., Room 1N-391, 307 Middletown-Lincroft Road, Lincroft, NJ, 07738, US

(21) Appl. No.: 10/283,742

(22) Filed: Oct. 30, 2002

(51) Int. Cl. G06F 9/46

(52) U.S. Cl. 719/313

(57) ABSTRACT

The frequency of sending system messages carrying quality-of-service information through a communications network is increased with increased communications traffic load in the network.

### TECHNICAL FIELD

This invention relates to control and management of communications networks.

### BACKGROUND OF THE INVENTION

In a communications network, system messages carry information that is used to control the network, in contrast to traffic messages which carry information between the users of the network. System messages are usually transmitted at a constant rate, i.e., at constant intervals, and upon occurrence of some predetermined significant event such as a change in the contents of a routing table. Some networks adapt system message frequency to the inverse of the traffic load in order to free up as much network bandwidth for traffic when the network becomes congested. Ironically, as traffic load increases and the network becomes more congested, the network has an ever-greater need for accurate and prompt control information. For example, as network congestion increases, quality of service usually decreases, and the network and its routing protocol have an increasing need for accurate and prompt quality-of-service information which they use to ensure that the quality of existing and new communications does not drop below acceptable levels.

### SUMMARY OF THE INVENTION

This invention is directed to solving these and other problems and disadvantages of the prior art. Generally, according to the invention, the frequency of system messages is increased with increasing communications load on the network. According to one aspect of the invention, a communications equipment (e.g., a router) for a communications network comprises a detector of communications traffic load in the network, and a sender of system messages that increases its frequency of sending system messages (e.g., messages carrying quality-of-service information) through the network with increasing detected communications traffic load. According to another aspect of the invention, frequency of sending system messages through a communications network is increased with increasing communications traffic load in the network.

While the invention has been characterized in terms of method, it also encompasses apparatus that performs the method. The apparatus preferably includes an effector—any entity that effects the corresponding steps, unlike a means—for each step. The invention further encompasses any computer-readable mediums containing instructions which, when executed in a computer cause the computer to perform the method steps.

The invention advantageously dynamically adapts the frequency of system messages to the determined present traffic load. This optimizes the network bandwidth used for updates of network control or management information, thereby improving network performance.

### BRIEF DESCRIPTION OF THE DRAWING

These and other features and advantages of the invention will become more apparent from the following description of an illustrative embodiment of the invention considered together with the drawing wherein:

FIG. 1 is a block diagram of an illustrative communications network; and

FIG. 2 is a flow diagram of system-message rate-determining operations of the nodes of the network of FIG. 1.

### DETAILED DESCRIPTION

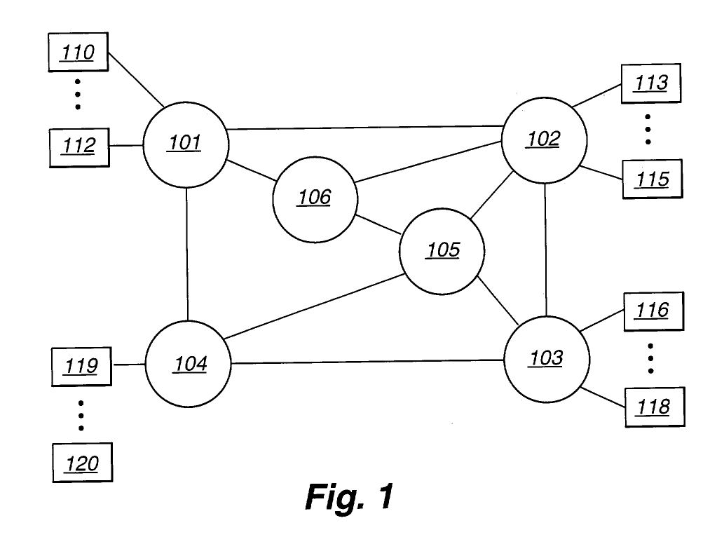

FIG. 1 shows an illustrative communications network 100 comprising a plurality of interconnected routing nodes 101-106 at least some of which are connected to user communications equipment 110-120. Nodes 101-106 transfer traffic messages between equipment 110-120. Nodes 101-106 also transfer system messages between each other. Nodes 101-106 are typically stored-program-controlled machines comprising, inter alia, computer-readable memory storing functional programs, a processor for executing the programs out of the memory, and interfaces to communications links to other nodes 101-106 and to equipment 110-120. Network 100 is illustratively the Internet or an intranet packet communications network.

As traffic load in network 100 increases, network occupancy and latency (transmission delays) also tend to increase, causing quality of service to decrease. Therefore, as network traffic increases, nodes 101-106 and their routing protocols need ever-more prompt and accurate quality-of-service information for use in making connection-routing and connection-establishment decisions in order to keep quality of service from falling below acceptable levels.

This need is met by varying the frequency of sending system messages that carry quality-of-service (QoS) information through the network directly with the traffic load. The system messages are separate messages (e.g., separate packets) from traffic-bearing messages, but the two message types share the bandwidth of the network. Illustratively, when the traffic load is less than a first threshold (e.g., 10%) the frequency of system messages between any two directly-connected nodes 101-106 is a minimum (e.g., one every 310 seconds). When the traffic load is greater than a second threshold (e.g., 90%), the frequency of system messages is a maximum (e.g., one every 10 seconds). And when the traffic load is between the thresholds, the frequency of system messages varies directly with the traffic load according to any desired formula that reflects the policy of the network. For example, the variation may be linear (proportional to the traffic load), tiered (step function), or exponential.

The quality-of-service measures are any desired measures, such as the conventional measures of available bandwidth, transmission-queue occupancy levels, buffer-overflow rates, transmission delays, or packet-loss rates. The system messages that communicate this information are also any desired type of messages. For example, if the network protocol is the Internet Protocol (IP), the system messages may be the ICMP messages; if the protocol is VRRP, the messages may be “hello” messages; and if the protocol is ATM, the messages may be PNNI messages.

At the receiving node, the information conveyed by the system messages is used in a conventional manner, such as to control the establishment and routing of new communications paths and the rerouting of existing communications paths.

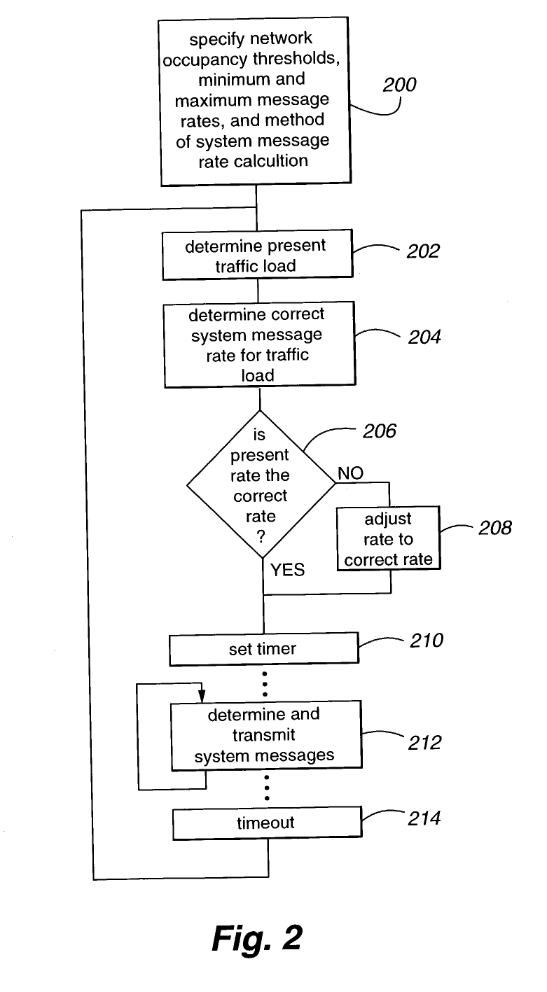

The relevant portion of the operation of each node 101-106 is flowcharted in FIG. 2. Initially, a network administrator specifies the minimum and maximum network-occupancy thresholds, the minimum and maximum system-message rates, and the method (e.g., a formula) for calculating the system-message rate between the thresholds, at step 200. Each manner of determining traffic load (see step 202) may have its own unique thresholds, and/or may have only one threshold. Illustratively, these parameters are identical and specified commonly for all nodes 101-106. Steps 202 et seq. are then performed either on a node-wide or a per-inter-node link basis. During operation of network 100, each node determines the traffic load that it is presently seeing or experiencing, at step 202. The traffic load determination may be a measure of buffer usage, used bandwidth, perceived QoS score, end-to-end delay, available bandwidth, or etc. The node then compares this load against the parameters that were specified at step 200 to determine what the correct system-message rate should presently be, at step 204, and compares the correct rate against the present rate, at step 206. Determination of the “correct” rate may involve negotiating with the other nodes for an “optimum” rate. If the two rates do not match, the node adjusts the present rate to the correct rate, at step 208. This is the rate at which the node will determine and transmit system messages indicating, e.g., its perceived quality of service, optimum path information, and/or link state information, at step 212. Following step 208, or if the two rates match at step 206, the node sets a timer that specifies when the rate should be reexamined, at step 210. Illustratively, the rate is reexamined after the transmission of every xth system message. When the timer expires, at step 214, the node returns to steps 202 et seq. to repeat the system-message rate determination and adjustment.

Of course, various changes and modifications to the disclosed illustrative embodiment of the invention will be apparent to those skilled in the art. These changes and modifications can be made without departing from the spirit and the scope of the invention and without diminishing its attendant advantages. It is therefore intended that such changes and modifications be covered by the following claims except insofar as limited by the prior art.

What is claimed is:

1. A method in a communications network comprising:
increasing frequency of sending system messages through the network with increasing communications traffic load in the network.

2. The method of claim 1 wherein:
increasing comprises
varying the frequency of the sending directly with variation in the communications traffic load in the network.

3. The method of claim 1 wherein:
increasing comprises
a node of the network increasing the frequency of the sending with increasing communications traffic load being handled by the node.

4. The method of claim 1 wherein:
increasing comprises
increasing the frequency of the sending of system messages which convey network control or management information among components of the network with increasing volume of traffic-bearing messages being handled by the network.

5. The method of claim 4 wherein:
the information comprises quality-of-service information.

6. The method of claim 1 wherein:
increasing comprises
a first router of the network increasing the frequency of the sending to a second router of the network with increasing communications traffic load on the first router.

7. The method of claim 1 wherein:
increasing comprises
determining the communications traffic load on the system;
in response to the determined traffic load not exceeding a first threshold, sending the system messages at a minimum frequency;
in response to the determined traffic load exceeding a second threshold, sending the system messages at a maximum frequency; and
in response to the determined traffic load being between the first and the second thresholds, varying the frequency of the sending directly with variation in the communications traffic load in the network.

8. The method of claim 7 wherein:
varying comprises one of linear varying, tiered varying, and exponential varying.

9. A computer-readable medium containing instructions which, when executed in a computer, cause the computer to perform the method of one of claims 1-8.

10. A communications equipment for a communications network comprising:
a detector of communications traffic load in the network; and
a sender of system messages that increases its frequency of sending system messages through the network with increasing said detected communications traffic load.

11. The communications equipment of claim 10 wherein:
the sender is adapted to vary the frequency of the sending directly with variation in the communications traffic load in the network.

12. The communications equipment of claim 10 comprising:
a router of communications traffic through the network.

13. The communications equipment of claim 12 wherein:
the sender increases the frequency of the sending with increasing communications traffic load being routed by the router.

14. The communications equipment of claim 10 wherein:
the detector detects a volume of traffic-bearing messages being handled by the network; and
the sender increases the frequency of the sending of system messages which convey network control or management information among components of the network with increasing said volume.

15. The communications equipment of claim 14 wherein:
the information comprises quality-of-service information.

16. The communications equipment of claim 10 wherein:
the sender comprises
means responsive to the determined traffic load not exceeding a first threshold, for sending the system messages at a minimum frequency;
means responsive to the determined traffic load exceeding a second threshold, for sending the system messages at a maximum frequency; and
means responsive to the determined traffic load being between the first and the second thresholds, for varying the frequency of the sending directly with variation in the communications traffic load in the network.

17. The communications system of claim 16 wherein:
varying comprises one of linear varying, tiered varying, and exponential varying.
